(19) United States
(12) Patent Application Publication
(10) Pub. No.: US 2019/0370730 A1
(43) Pub. Date: Dec. 5, 2019

(54) METHOD FOR OBTAINING LOGISTICS DOCUMENT INFORMATION, AND RELATED DEVICE

(71) Applicant: CAINIAO SMART LOGISTICS HOLDING LIMITED, GRAND CAYMAN (KY)

(72) Inventor: Yulin HE, HANGZHOU (CN)

(21) Appl. No.: 16/545,918

(22) Filed: Aug. 20, 2019

Related U.S. Application Data
(63) Continuation of application No. PCT/CN2018/075895, filed on Feb. 9, 2018.

(30) Foreign Application Priority Data
Feb. 22, 2017 (CN) 201710097547.1

(51) Int. Cl. G06Q 10/08; G06F 16/93

(52) U.S. Cl. CPC G06Q 10/08; G06F 16/93

(57) ABSTRACT

A method for obtaining logistics label information and related apparatuses, applied to a logistics management server may include receiving logistics address information from a terminal. The method may include obtaining a logistics platform setting factor, and determining, according to the logistics platform setting factor, a logistics platform corresponding to the logistics address information. The method may also include obtaining a logistics label identifier corresponding to the logistics platform, generating logistics label information according to the logistics label identifier, and sending the logistics label information to the terminal. The application may provide a manner of automatically obtaining logistics label information, thereby improving efficiency and reducing an error rate. In addition, in this application, after determining a logistics platform, a logistics management server directly may obtain a logistics label identifier corresponding to the logistics platform, thereby avoiding repeated interactions between the logistics management server and a terminal, thereby saving time and system resources.

### CROSS-REFERENCE TO RELATED APPLICATIONS

This application is a continuation application of International Patent Application No. PCT/CN2018/075895, filed on Feb. 9, 2018, which is based on and claims priority to the Chinese Patent Application No. 201710097547.1, filed on Feb. 22, 2017 and entitled “METHOD FOR OBTAINING LOGISTICS DOCUMENT INFORMATION, AND RELATED DEVICE,” the content of all of which is incorporated herein by reference in their entirety.

### TECHNICAL FIELD

This application relates to the field of Internet technology, and in particular, to a method for obtaining logistics label information and related apparatuses.

### BACKGROUND

With the development of Internet technology, it is already widely popular to use an Internet platform to provide users with items. Corresponding logistics label information is usually required to provide a user with an item. For example, a logistics label on which logistics label information is printed is bonded to an item, and a logistics company provides a user with the corresponding item according to the logistics label information.

Currently, logistics label information is mainly obtained in a manual manner. Specifically, in a process of obtaining logistics label information, a corresponding logistics company is manually chosen according to logistics address information, and a staff obtains a logistics label identifier from the corresponding logistics company, including logistics label information accompanied with the logistics label identifier. After the logistics label information is obtained, the logistics label information may be printed or manually filled on a logistics label.

However, such manual manner has relatively low efficiency and thus is easily subject to a relatively high error rate. Therefore, how to automatically obtain logistics label information is currently an urgent problem that needs to be resolved.

### SUMMARY

To resolved the above technical problems, this application provides a method for obtaining logistics label information and related apparatuses to obtain the logistics label information automatically, thereby improving efficiency and reducing an error rate.

Technical solutions to the problems to be resolved by this application are described herein:

The embodiments of this application provide a method for obtaining logistics label information, applied to a logistics management server. The method may include receiving logistics address information from a terminal, obtaining a logistics platform setting factor, and determining, according to the logistics platform setting factor. A logistics platform may correspond to the logistics address information. The method may also include obtaining a logistics label identifier corresponding to the logistics platform, generating, according to the logistics label identifier, logistics label information, and sending the logistics label information to the terminal.

In some embodiments, the obtaining the logistics label identifier corresponding to the logistics platform may include determining a logistics platform server corresponding to the logistics platform, sending an identifier request to the logistics platform server and receiving the logistics label identifier from the logistics platform server according to the identifier request.

In some embodiments, the obtaining the logistics platform setting factor may include obtaining a preset logistics platform setting factor, and/or receiving a logistics platform setting factor from the terminal. In some embodiments, the logistics platform setting factor may be one or more setting factors including: a matching degree between coverage of a logistics platform and the logistics address information, a priority of a logistics platform, a quality of service index of a logistics platform, and a cost index of a logistics platform. In some embodiments, the quality of service index of a logistics platform may be one or more quality indices, including a delivery time and a service feedback index of a logistics platform.

Some embodiments provide a method for obtaining logistics label information, applied to a terminal. The method includes: sending logistics address information to a logistics management server, and receiving logistics label information from the logistics management server. The logistics label information may be generated according to a logistics label identifier that corresponds to a logistics platform. The logistics platform may be determined according to a logistics platform setting factor and corresponds to the logistics address information.

In some embodiments, the method may further include: after receiving the logistics label information from the logistics management server, printing a logistics label via a printing device. The logistics label may be printed with the logistics label information. In some embodiments, the logistics label information may be generated according to the logistics label identifier and an address segment identifier corresponding to the logistics address information.

In some embodiments, the method may further include sending the logistics platform setting factor to the logistics management server. In some embodiments, the logistics platform setting factor may be one or more setting factors, including a matching degree between coverage of a logistics platform and the logistics address information, a priority of a logistics platform, a quality of service index of a logistics platform, and a cost index of a logistics platform. The quality of service index of a logistics platform may be one or more quality indices, including a delivery time and a service feedback index of a logistics platform.

Some embodiments provide a logistics management server including a receiving unit, a determining unit, a generation unit, a sending unit. The receiving unit may be configured to receive logistics address information from a terminal. The determining unit may be configured to: obtain a logistics platform setting factor, and determine, according to the logistics platform setting factor, a logistics platform corresponding to the logistics address information. The generation unit may be configured to: obtain a logistics label identifier corresponding to the logistics platform, and generate logistics label information according to the logistics label identifier. The sending unit may be configured to send the logistics label information to the terminal.

Some embodiments provide a terminal including a sending unit and a receiving unit. The sending unit may be configured to send logistics address information to a logistics management server. The receiving unit may be configured to receive logistics label information from the logistics management server. The logistics label information may be generated according to a logistics label identifier corresponding to a logistics platform. The logistics platform may be determined according to a logistics platform setting factor and corresponds to the logistics address information.

Some embodiments provide a logistics management server including a receiver, a processor, and a transmitter. The receiver may be configured to receive logistics address information from a terminal, obtain a logistics platform setting factor, determine, according to the logistics platform setting factor, a logistics platform corresponding to the logistics address information, obtain a logistics label identifier corresponding to the logistics platform, and generate logistics label information according to the logistics label identifier. The transmitter may be configured to send the logistics label information to the terminal.

In some embodiments, the processor may be further configured to generate an address segment identifier corresponding to the logistics address information. When the logistics label information is generated according to the logistics label identifier, the processor may be configured to generate the logistics label information according to the logistics label identifier and the address segment identifier.

In some embodiments, when the logistics label identifier corresponding to the logistics platform is obtained, the processor may be configured to: determine a logistics platform server corresponding to the logistics platform, send an identifier request to the logistics platform server via the transmitter, and receive, via the receiver, the logistics label identifier from the logistics platform server according to the identifier request.

In some embodiments, when the logistics platform setting factor is obtained, the processor may be configured to obtain a preset logistics platform setting factor on the logistics management server, and/or, receive, via the receiver, a logistics platform setting factor from the terminal. In some embodiments, the logistics platform setting factor may be one or more setting factors including a matching degree between coverage of a logistics platform and the logistics address information, a priority of a logistics platform, a quality of service index of a logistics platform, and a cost index of a logistics platform. The quality of service index of a logistics platform may be one or more quality indices, including a delivery time and a service feedback index of a logistics platform.

Some embodiments provide a terminal including: a transmitter and a receiver. The transmitter may be configured to send logistics address information to a logistics management server. The receiver may be configured to receive logistics label information from the logistics management server. The logistics label information may be generated according to a logistics label identifier corresponding to a logistics platform. The logistics platform may be determined according to a logistics platform setting factor and corresponds to the logistics address information.

In some embodiments, the terminal may further include a processor. The processor may be configured to: print, after the receiver receives the logistics label information from the logistics management server, a logistics label accompanying the logistics label information via a printing device. In some embodiments, the logistics label information may be generated according to the logistics label identifier and an address segment identifier corresponding to the logistics address information.

In some embodiments, the transmitter may be further configured to send the logistics platform setting factor to the logistics management server. In some embodiments, the logistics platform setting factor may be one or more setting factors, including: a matching degree between coverage of a logistics platform and the logistics address information, a priority of a logistics platform, a quality of service index of a logistics platform, and a cost index of a logistics platform. The quality of service index of a logistics platform may be one or more quality indices, including a delivery time and a service feedback index of a logistics platform.

As can be known from the foregoing technical solutions, in the embodiments of this application, a logistics management server may receive logistics address information from a terminal, obtain a logistics platform setting factor, and determine, according to the logistics platform setting factor, a logistics platform corresponding to the logistics address information. After the logistics platform is determined, the logistics management server may obtain a logistics label identifier corresponding to the logistics platform, generate logistics label information according to the logistics label identifier, and send the generated logistics label information to the terminal. It can be learned that some embodiments provide a manner of automatically obtaining logistics label information, thereby improving efficiency and reducing an error rate.

In addition, in some embodiments, after determining the logistics platform, the logistics management server may not need to feed back the determined logistics platform to the terminal. Instead, the logistics management server may directly obtain the logistics label identifier corresponding to the logistics platform, thereby avoiding repeated interactions between the logistics management server and the terminal, and shortening the time used and saving system resources.

### BRIEF DESCRIPTION OF THE DRAWINGS

To describe the technical solutions in the embodiments of this application more clearly, the following briefly describes the accompanying drawings required for describing the embodiments. The accompanying drawings in the following description show only some embodiments of this application, and a person of ordinary skill in the art may still derive other drawings from these accompanying drawings.

FIG. 1 is a block diagram of a logistics communications system according to an embodiment of this application.

FIG. 2 is a schematic diagram of a logistics label according to an embodiment of this application.

FIG. 3 is a flowchart of a method according to an embodiment of this application.

FIG. 4 is a block diagram of an apparatus for a logistics management server according to an embodiment of this application.

FIG. 5 is a block diagram of an apparatus for a terminal according to an embodiment of this application.

FIG. 6 is a block diagram of another apparatus for a logistics management server according to an embodiment of this application.

FIG. 7 is a block diagram of another apparatus for a terminal according to an embodiment of this application.

### DETAILED DESCRIPTION OF THE INVENTION

To make the technical solutions in this application more comprehensible to persons skilled in the art, the following clearly and completely describes the technical solutions in the embodiments of this application with reference to the accompanying drawings in the embodiments of this application. The described embodiments are only some of the embodiments of this application rather than all of the embodiments. All other embodiments obtained by a person of ordinary skill in the art based on the embodiments of this application without creative efforts shall fall within the protection scope of this application.

After a user buys an item on an e-commerce platform, a seller determines a logistics company that delivers the item, and attaches a logistics label printed with logistics label information to the item. The logistics company delivers the corresponding item to the user according to the logistics label information. The logistics label information usually includes a logistics label identifier corresponding to a logistics platform (each logistics company has a corresponding logistics platform), and additionally may further include logistics address information (for example, recipient address information), a user's telephone number, etc.

Currently, logistics label information is mainly obtained in a manual manner. Specifically, a corresponding logistics company, for example, ZTO Express or SF Express, is manually chosen according to logistics address information such as recipient address information. A staff obtains a logistics label identifier from the corresponding logistics company, including logistics label information accompanied with the logistics label identifier. After the logistics label information is obtained, the logistics label information may be printed or manually filled on a logistics label, which is attached to an item for the corresponding logistics company to deliver the item.

However, such manual manner has relatively low obtaining efficiency and is easily subject to a relatively high error rate. Therefore, how to automatically obtain logistics label information is currently an urgent problem that needs to be resolved.

A manner of automatically obtaining logistics label information is provided below. Because there are various logistics companies and different logistics companies use different logistics platform servers, for security concerns, a third-party logistics management server is usually used as a communications medium to communicate with a terminal used by a seller and a logistics platform server.

The seller may send the logistics address information such as a recipient address information via the terminal, and send a logistics platform setting factor set by the seller to the logistics management server. The logistics management server may determine, according to the logistics platform setting factor, a logistics platform corresponding to the logistics address information. The logistics platform setting factor is a factor considered in setting the logistics platform, usually including a delivery time of a logistics platform, a cost index of a logistics platform, and logistics platforms that cooperate with the seller. For example, the logistics platform setting factors set by the seller includes a cost index of a logistics platform and logistics platforms that cooperate with the seller. Therefore, to determine a logistics platform, a logistics platform having the smallest cost index, for example, having the lowest logistics expenditure, is chosen from the logistics platforms that cooperate with the seller.

After the logistics platform is determined, the logistics management server feeds back the determined logistics platform to the terminal used by the seller for confirmation. If the seller confirms the use of the logistics platform, the terminal may send a confirmation message to the logistics management server. The logistics management server may generate a corresponding logistics label identifier according to the determined logistics platform, generate logistics label information according to the logistics label identifier, and return the logistics label information to the terminal used by the seller. The seller may print a logistics label accompanied with the logistics label information.

However, although logistics label information can be automatically obtained by using the foregoing process, the logistics management server may need to determine a logistics platform and identify the determined logistics platform to the terminal used by the seller. After the determined logistics platform is confirmed, the logistics management server may continue to generate a corresponding logistics label identifier according to the determined logistics platform, thereby generating logistics label information. This process requires repeated interactions between the terminal and the logistics management server that may result in a relatively long process time and a waste of system resources. In addition, in the foregoing process, only several simple factors, including a delivery time of a logistics platform, a cost index of a logistics platform, and logistics platforms that cooperate with the seller, are generally considered to determine a logistics platform. Therefore, because a chosen logistics platform usually cannot meet a requirement, the seller may need to manually select a logistics platform that may result in a waste of system resources.

The techniques disclosed herein provide a method for obtaining logistics label information and related apparatuses, to automatically obtain the logistics label information, thereby improving efficiency and reducing an error rate. In some embodiments, the method may avoid repeated interactions between terminals to save time and system resources. In some embodiments, a logistics platform can be determined according to more comprehensive setting factors, so that a logistics platform and logistics label information that meet a seller's requirement may be recommended to the seller, thereby further saving system resources.

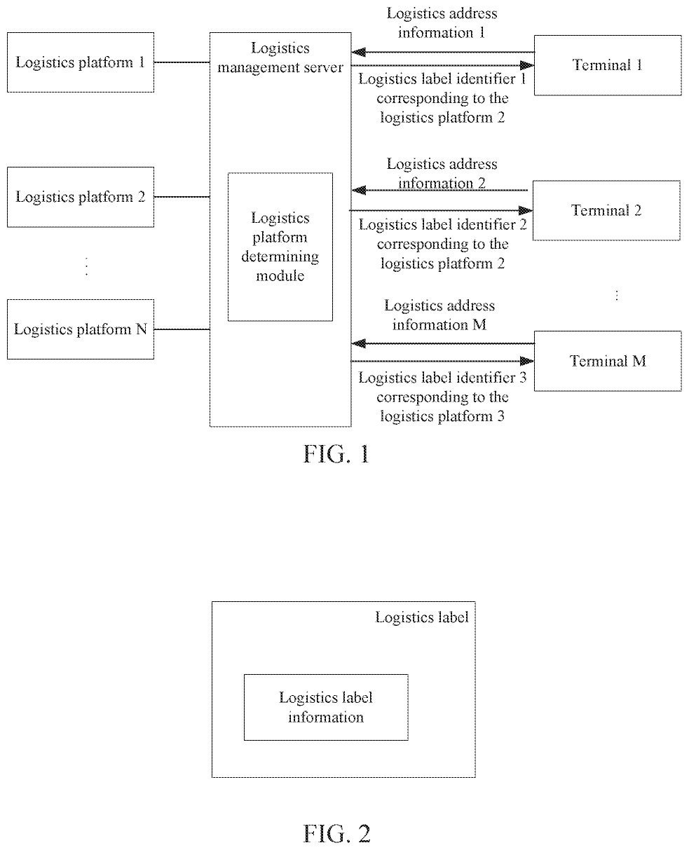

The logistics communications system in accordance with some embodiments may include a logistics management server, at least two logistics platforms, and at least one terminal. As shown in FIG. 1, the logistics communications system may include a logistics management server, N logistics platforms, and N terminals. The logistics management server may be connected to the logistics platforms and the terminals. The logistics management server may be a server corresponding to a logistics management platform, and may be a computer, a cloud server, a server cluster, etc. The terminal may be a terminal used by the seller, including a computer, a mobile phone, a tablet computer, a personal electronic assistant (PDA), etc. The seller may install a corresponding application on the terminal, and the application may enable the terminal to communicate with the logistics management server.

In some embodiments, after an e-commerce platform generates an electronic order according to a user's request, a corresponding terminal may obtain order information corresponding to the electronic order. The order information may include logistics address information corresponding to the electronic order, for example, sender address information and recipient address information corresponding to the electronic order. After obtaining the order information, the corresponding terminal may send the logistics address information to the logistics management server. As shown in FIG. 1, a terminal 1 sends logistics address information 1 to the logistics management server, a terminal 2 sends logistics address information 2 to the logistics management server, and a terminal M sends logistics address information M to the logistics management server.

A logistics platform determining module is installed in the logistics management server. After receiving the logistics address information, the logistics platform determining module may determine, according to a logistics platform setting factor, a logistics platform corresponding to the logistics address information. For example, in FIG. 1, the logistics platform determining module may determine that a logistics platform 2 corresponds to the logistics address information 1, a logistics platform 2 corresponds to the logistics address information 2, and determines that a logistics platform 3 corresponds to the logistics address information M.

After the logistics platform determining module determines the logistics platform, the logistics management server may obtain a corresponding logistics label identifier according to the determined logistics platform. The logistics management server may generate the logistics label identifier. In some embodiments, the logistics management server may send an identifier request to a logistics platform server corresponding to the logistics platform, and receive the logistics label identifier from the logistics platform server according to the identifier request. For example, after determining that the logistics platform is a logistics platform corresponding to ZTO Express, the logistics management server may obtain a courier order number of ZTO Express from a logistics platform server corresponding to the logistics platform of ZTO Express.

After obtaining the logistics label identifier, the logistics management server may generate logistics label information according to the logistics label identifier (i.e. the generated logistics label information may include the logistics label identifier). The logistics label information may further include an address segment identifier or the like in addition to the logistics label identifier. The address segment identifier may be an identifier used by a logistics company to perform classified transportation on a delivery item according to the logistics address information. Each section identifier may correspond to a logistics site or may correspond to a delivery person. For example, an address segment label may include a two-segment address code and/or a three-segment address code. The two-segment address code may correspond to a logistics site. The three-segment address code may correspond to a delivery person at the logistics site. After receiving the logistics address information, the logistics management server may generate, according to the logistics address information, the address segment identifier corresponding to the logistics address information, and generate the logistics label information according to the logistics label identifier and the address segment identifier.

After generating the logistics label information, the logistics management server may return the logistics label information to the terminal. For example, in FIG. 1, logistics label information sent by the logistics management server to the terminal 1 may include a logistics label identifier 1 corresponding to a logistics platform 1 logistics label information sent by the logistics management server to the terminal 2 may include a logistics label identifier 2 corresponding to a logistics platform 2, and logistics label information sent by the logistics management server to the terminal M may include a logistics label identifier 3 corresponding to a logistics platform 3. It should be noted that any terminal in the embodiments of this application may send one or more pieces of logistics address information to the logistics management server. The logistics management server may generate corresponding logistics label information for each piece of logistics address information and return the logistics label information to a corresponding terminal.

If the seller does not use a logistics platform determined by the logistics management server but instead uses another logistics platform, the terminal may send a modification message for the logistics label information to the logistics management server, and the seller may manually enter or select an identifier of another logistics platform on the terminal, and may further manually enter a logistics label identifier. In some embodiments, the terminal may send an identifier of another logistics platform to the logistics management server by using a modification message. The logistics management server may obtain a corresponding logistics label identifier according to the identifier of the logistics platform, and return the obtained logistics label identifier to the terminal. The terminal may similarly obtain the logistics label information according to the logistics platform selected by the seller. After obtaining the logistics label information, the terminal may print a logistics label shown in FIG. 2 via a printing device, where the printed logistics label is accompanied with the logistics label information.

Some embodiments provide a manner of automatically obtaining logistics label information, thereby improving obtaining efficiency and reducing an error rate. In some embodiments, after determining the logistics platform, the logistics management server may not need to feed back the determined logistics platform to the terminal. Instead, the logistics management server may directly obtain the logistics label identifier corresponding to the logistics platform and then return back the logistics label identifier to the terminal, thereby avoiding repeated interactions between the logistics management server and the terminal, and saving more time and system resources.

In some embodiments, all logistics platform setting factors may be preset in a logistics management server, and the logistics management server may obtain a logistics platform setting factor locally. In some embodiments, all logistics platform setting factors may be set by a seller, and a logistics management server may receive a logistics platform setting factor from a terminal. In some embodiments, some logistics platform setting factors are preset in a logistics management server, and some logistics platform setting factors are set by a seller. In some embodiments, the logistics platform setting factors may be more comprehensive, and a requirement of a seller may be considered in a plurality of aspects. The logistics platform setting factor may be one or more setting factors, including a matching degree between the coverage of a logistics platform and the logistics address information, a priority of a logistics platform, a quality of service index of a logistics platform, and a cost index of a logistics platform. The quality of service index of a logistics platform may be one or more quality indices including a delivery time and a service feedback index of a logistics platform. In some embodiments, a logistics platform and logistics label information that better meet a requirement of a seller may be recommended to the seller to saving system resources.

A method for obtaining logistics label information according to an embodiment of this application is described below.

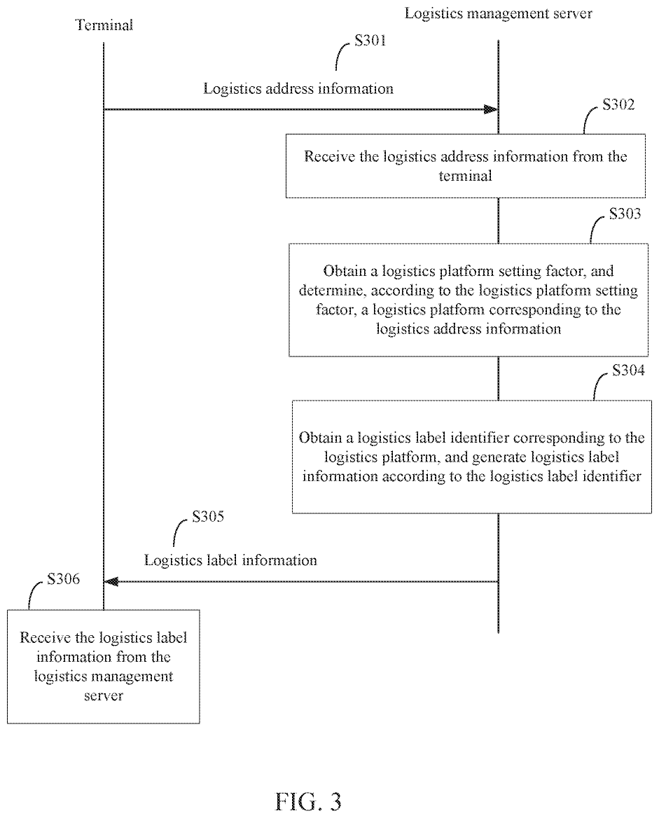

FIG. 3 illustrates a method for obtaining user information in accordance with some embodiments. The method may be used in a communications system shown in FIG. 1, including S301-S306.

At step S301, a terminal may send logistics address information to a logistics management server.

In some embodiments, the logistics management server may be a server corresponding to a logistics management platform, including a computer, a cloud server, a server cluster, etc. The terminal used by a seller may include a computer, a mobile phone, a tablet computer, a PDA, etc. The seller may install a corresponding application on the terminal, and the application may enable the terminal to communicate with the logistics management server.

The logistics address information may be address information corresponding to a logistics process. In some embodiments, the address information may include recipient address information. In some embodiments, the address information may include sender address information and recipient address information. The terminal may send the logistics address information to the logistics management server, and may further send other logistics information, such as weight information of an item and a source warehouse identifier, to the logistics management server, so that the logistics management server may determine a logistics platform according to the other logistics information and the logistics address information.

At 5302, the logistics management server may receive the logistics address information from the terminal.

At 5303, the logistics management server may obtain a logistics platform setting factor, and determine, according to the logistics platform setting factor, a logistics platform corresponding to the logistics address information.

In some embodiments, the logistics platform setting factor may be a factor considered in setting the logistics platform. All logistics platform setting factors may be preset in the logistics management server, and the logistics management server may obtain preset logistics platform setting factor on the logistics management server. In some embodiments, all logistics platform setting factors may be set by the seller, and the logistics management server may receive a logistics platform setting factor from the terminal. In some embodiments, some logistics platform setting factors may be preset on the logistics management server, and some logistics platform setting factors are set by the seller.

At, 5304, the logistics management server may obtain a logistics label identifier corresponding to the logistics platform, and generate logistics label information according to the logistics label identifier.

In some embodiments, the logistics management server may generate the logistics label identifier. In some embodiments, the logistics management server may determine a logistics platform server corresponding to the logistics platform, send an identifier request to the logistics platform server, and receive the logistics label identifier from the logistics platform server according to the identifier request. For example, after determining that the logistics platform is a logistics platform corresponding to ZTO Express, the logistics management server may obtain a courier order number of ZTO Express from a logistics platform server corresponding to the logistics platform of ZTO Express.

In some embodiments, the logistics label information generated by the logistics management server may further include an address segment identifier in addition to the logistics label identifier. The address segment identifier may be used to identify an address class of the logistics address information, so that address classification transportation can be rapidly performed on a delivery item, thereby reducing a time for logistics transportation. In some embodiments, the logistics management server may generate, according to a preset address segmentation rule, the address segment identifier corresponding to the logistics address information, and generate the logistics label information according to the logistics label identifier and the address segment identifier.

At S305, the logistics management server may send the logistics label information to the terminal.

In some embodiments, after generating the logistics label information, the logistics management server may send the generated logistics label information to the terminal. In some embodiments, the logistics management server may further send the logistics label information to the logistics platform server corresponding to the logistics platform, and the logistics platform server may record the logistics label information.

At S306, the terminal may receive the logistics label information from the logistics management server.

In some embodiments, after receiving the logistics label information, the terminal may print a logistics label with the logistics label information via a printing device. If the terminal does not use a logistics platform determined by the logistics management server but instead uses another logistics platform, the terminal may send a modification message for the logistics label information to the logistics management server, and may manually enter or select an identifier of another logistics platform on the terminal, and may further manually enter a logistics label identifier. In some embodiments, the terminal may use a modification message to send an identifier of another logistics platform to the logistics management server. The logistics management server may obtain a corresponding logistics label identifier according to the identifier of the logistics platform, and return the obtained logistics label identifier to the terminal. The terminal may obtain the logistics label information according to the logistics label identifier.

In some embodiments, the logistics management server may receive the logistics address information from the terminal, obtain the logistics platform setting factor, and determine, according to the logistics platform setting factor, the logistics platform corresponding to the logistics address information. After determining the logistics platform, the logistics management server may obtain the logistics label identifier corresponding to the logistics platform, where the logistics label information may be generated according to the logistics label identifier, and send the generated logistics label information to the terminal. Some embodiments provide a manner of automatically obtaining the logistics label information, thereby improving obtaining efficiency and reducing an error rate.

In some embodiments, after determining the logistics platform, the logistics management server may not need to feed the determined logistics platform to the terminal. Instead, the logistics management server directly may obtain the logistics label identifier corresponding to the logistics platform, thereby avoiding repeated interactions between the logistics management server and the terminal, and saving more time and system resources.

In some embodiments, the logistics platform setting factors may be comprehensive so that a seller's requirements may be considered in different perspective. In some embodiments, the logistics platform setting factor may be one or more setting factors, including: a matching degree between coverage of a logistics platform and the logistics address information, a priority of a logistics platform, a quality of service index of a logistics platform, and a cost index of a logistics platform, each of which is described below.

In some embodiments, the matching degree between the coverage of a logistics platform and the logistics address information may be determined by whether an address corresponding to the logistics address information is within reach of the logistics platform. The coverage of the logistics platform may be preset in the logistics management server. For example, the delivery coverage of SF Express may include the address corresponding to the logistics address information, and thus the delivery coverage of SF Express and the logistics address information have a relatively high matching degree. The delivery coverage of ZTO Express may not include the address corresponding to the logistics address information, and thus the delivery coverage of ZTO Express and the logistics address information may have a relatively low matching degree. Therefore, a logistics platform with a relatively high matching degree may be usually selected.

In some embodiments, the priority of a logistics platform may be set in the different aspects, including a logistics platform remarked by a seller or a user, a logistics platform that cooperates with a seller, and a logistics platform (preset in the logistics management server) recommended by a logistics management platform. For example, to determine a logistics platform, a logistics platform may be first chosen from logistics platforms that cooperate with the seller. Then, the logistics platform may be chosen from logistics platforms recommended by the logistics management platform, and may be finally chosen according to a logistics platform remarked by a seller or a user.

The quality of service index of a logistics platform may be used to reflect the quality of a logistics service of the logistics platform, including a delivery time and a service feedback index of a logistics platform. The delivery time of a logistics platform may include: a collect-dispatch time (a time from notifying collection of an item to starting to dispatch the item) of a logistics platform, and a dispatch-sign time (a time from starting to dispatch the item to receiving and signing for the item by the user) of a logistics platform or the like. The service feedback index may be reflected by one or more parameters, including a quantity of negative comments of a logistics platform, a quantity of negative comments of a servant of a logistics platform, a quantity of false signatures, and a quantity of refunds.

In some embodiments, the cost index of a logistics platform may be used to reflect an expenditure charged for a logistics service by the logistics platform.

In some embodiments, the logistics management server may determine, according to the logistics platform setting factor, a logistics platform corresponding to the logistics address information in S303. For example, if the logistics management server determines that a logistics platform A is remarked in a seller or a user's remark information, it further determines whether the logistics platform A cooperates with the seller, and whether the logistics platform A can reach the address corresponding to the logistics address information. If either determining result discussed above is no, the logistics platform A may not be a logistics platform that cooperates with the seller or the logistics platform A cannot reach the address corresponding to the logistics address information. A logistics platform will be reselected according to other setting factors. If both the determining results are yes, the logistics platform A may be chosen as the logistics platform corresponding to the logistics address information.

If the logistics management server determines that logistics platform is not remarked in the seller or the user's remark information, a logistics platform is then selected based on one or more conditions, including a logistics platform that cooperates with the seller, a logistics platform recommended by the logistics management platform, and a logistics platform that can reach the address corresponding to the logistics address information. In some embodiments, assuming a plurality of logistics platforms meets the requirements, those logistics platforms may be sorted according to a quality of service index and a cost index. A top logistics platform will be chosen as the logistics platform corresponding to the logistics address information. The quality of service index of a logistics platform may be calculated according to one or more factors, including a collect-dispatch time and a dispatch-sign time of a logistics platform, a quantity of negative comments of a logistics platform, a quantity of negative comments about a servant of a logistics platform, a quantity of false signatures, and a quantity of refunds.

Accordingly, in some embodiments, a logistics platform can be determined by combining the foregoing comprehensive setting factors, so that a logistics platform and logistics label information that better meet a requirement of a seller can be recommended to the seller, thereby further saving system resources.

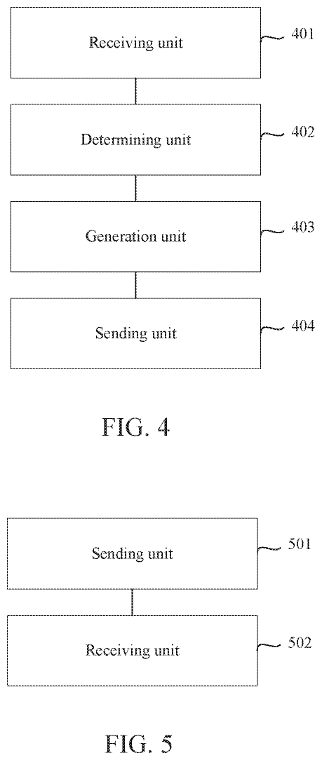

FIG. 4 illustrates an apparatus of a logistics management server embodiment, including a receiving unit 401, a determining unit 402, a generation unit 403, and a sending unit 404.

The receiving unit 401 may be configured to receive logistics address information from a terminal. The determining unit 402 may be configured to obtain a logistics platform setting factor, and determine, according to the logistics platform setting factor, a logistics platform corresponding to the logistics address information. The generation unit 403 may be configured to obtain a logistics label identifier corresponding to the logistics platform, and generate logistics label information according to the logistics label identifier. In some embodiments, the sending unit 404 is configured to send the logistics label information to the terminal.

FIG. 5 illustrates an apparatus of a terminal. This embodiment includes a sending unit 501 and a receiving unit 502.

The sending unit 501 may be configured to send logistics address information to a logistics management server. The receiving unit 502 may be configured to receive logistics label information from the logistics management server. In some embodiments, the logistics label information may be generated according to a logistics label identifier corresponding to a logistics platform, and the logistics platform may be a logistics platform that is determined according to a logistics platform setting factor and corresponds to the logistics address information.

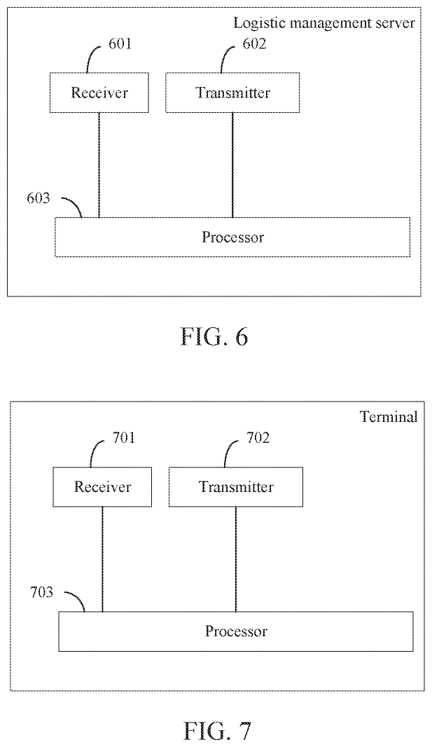

Referring now to FIG. 6, it illustrates an apparatus of a logistics management server from the hardware processing aspect, including a receiver 601, a transmitter 602, and a processor 603. The processor 603 is connected to the receiver 601 and the transmitter 602.

The receiver 601 may be configured to receive logistics address information from a terminal. The processor 603 may be configured to obtain a logistics platform setting factor, determine, according to the logistics platform setting factor, a logistics platform corresponding to the logistics address information, obtain a logistics label identifier corresponding to the logistics platform, and generate logistics label information according to the logistics label identifier. The transmitter 602 may be configured to send the logistics label information to the terminal.

In some embodiments, the processor may be configured to generate an address segment identifier corresponding to the logistics address information. When the logistics label information is generated according to the logistics label identifier, the processor may be configured to generate the logistics label information according to the logistics label identifier and the address segment identifier.

In some embodiments, when the logistics label identifier corresponding to the logistics platform is obtained, the processor may be configured to determine a logistics platform server corresponding to the logistics platform, send an identifier request to the logistics platform server by using the transmitter, and receive, via the receiver, the logistics label identifier from the logistics platform server according to the identifier request.

In some embodiments, when the logistics platform setting factor is obtained, the processor may be configured to obtain a preset logistics platform setting factor on the logistics management server, and/or receive, via the receiver, a logistics platform setting factor from the terminal.

In some embodiments, the logistics platform setting factor may be one or more setting factors including a matching degree between coverage of a logistics platform and the logistics address information, a priority of a logistics platform, a quality of service index of a logistics platform, and a cost index of a logistics platform. The quality of service index of a logistics platform may be one or more quality indices, including a delivery time and a service feedback index of a logistics platform.

FIG. 7 illustrates an apparatus of a terminal, including a receiver 701 and a transmitter 702.

The transmitter 702 may be configured to send logistics address information to a logistics management server. The receiver 701 may be configured to receive logistics label information from the logistics management server. The logistics label information may be generated according to a logistics label identifier corresponding to a logistics platform, and the logistics platform is a logistics platform that is determined according to a logistics platform setting factor and corresponds to the logistics address information.

In some embodiments, the terminal may further include a processor 703, where the processor 703 is connected to the transmitter 702 and the receiver 701. The processor 703 may be configured to print, after the receiver receives the logistics label information from the logistics management server, a logistics label accompanying the logistics label information via a printing device.

In some embodiments, the logistics label information may be generated according to the logistics label identifier and an address segment identifier corresponding to the logistics address information. In some embodiments, the transmitter may be further configured to send the logistics platform setting factor to the logistics management server.

In some embodiments, the logistics platform setting factor may be one or more setting factors including a matching degree between coverage of a logistics platform and the logistics address information, a priority of a logistics platform, a quality of service index of a logistics platform, and a cost index of a logistics platform. The quality of service index of a logistics platform may be one or more quality indices, including a delivery time and a service feedback index of a logistics platform.

Some embodiments provide a logistics communications system. The logistics communications system may include a logistics management server and a terminal. The logistics management server may be configured to receive logistics address information from the terminal, obtain a logistics platform setting factor, determine, according to the logistics platform setting factor, a logistics platform corresponding to the logistics address information, obtain a logistics label identifier corresponding to the logistics platform, generate logistics label information according to the logistics label identifier, and send the logistics label information to the terminal. The terminal may be configured to send the logistics address information to the logistics management server, and receive the logistics label information from the logistics management server.

Persons skilled in the art can clearly understand that, for convenience and simplicity of description, for the specific work process of the systems, apparatuses, and units described above, refer to the corresponding process in the aforementioned methods, which are no longer repeated herein.

In the embodiments provided by this application, it should be understood that the systems, apparatuses, and methods disclosed may be implemented in other forms. For example, the apparatus described above are merely exemplary. For example, the division of units is merely logical functional division, and there are other division forms in real application. For example, a plurality of units or components may be combined or be integrated to another system, or some features may be omitted or not be executed. In another aspect, the coupling, direct coupling, or communication connection there between which is displayed or discussed may be indirect coupling or communication connection of interfaces, apparatuses, or units, and may be electrical, mechanical, or in other forms.

Units described as separate components may be or may not be physically separated. Components shown as units may be or may not be physical units, that is, may be integrated or distributed to a plurality of network units. Some or all of the units may be selected to achieve the objectives of the solutions of the embodiments according to actual requirements.

In addition, the functional units in the embodiments of this application may either be integrated in a processing unit, or each unit may be a separate physical unit. Alternatively, two or more of the units are integrated in one unit. The integrated unit may be implemented in the form of hardware, or may be implemented in the form of a software functional unit.

If implemented in the form of software functional units and sold or used as an independent product, the integrated units may be stored in a computer readable storage medium. Based on this, the foregoing technical solutions of this application or the entire technical solution or the part that makes contributions to the existing technologies can be substantially embodied in the form of a software product. The computer software product may be stored in a storage medium and contain several instructions to instruct one piece of computer equipment (for example, a personal computer, a logistics management server, or network equipment) to perform all or a part of the steps of the method described in the embodiments of this application. The storage medium may be any medium that is capable of storing program code, such as a USB flash drive, a removable hard disk, a ROM, a RAM, a magnetic disk or an optical disk.

It should be noted that the above embodiments are merely provided for describing the technical solutions of this application, but not intended to limit this application. It should be understood by a person of ordinary skill in the art that although this application has been described in detail with reference to the embodiments, modifications can be made to the technical solutions described in the embodiments, or equivalent replacements can be made to some technical features in the technical solutions, as long as such modifications or replacements do not cause the essence of corresponding technical solutions to depart from the spirit and scope of this application.

What is claimed is:

1. A method for obtaining logistics label information, comprising:
receiving logistics address information from a terminal;
obtaining a logistics platform setting factor, and determining, according to the logistics platform setting factor, a logistics platform corresponding to the logistics address information;
obtaining a logistics label identifier corresponding to the logistics platform, and generating, according to the logistics label identifier, logistics label information; and
sending the logistics label information to the terminal.

2. The method according to claim 1, further comprising:
generating an address segment identifier corresponding to the logistics address information; and
wherein the generating, according to the logistics label identifier, logistics label information comprises:
generating the logistics label information according to the logistics label identifier and the address segment identifier.

3. The method according to claim 1, wherein the obtaining the logistics label identifier corresponding to the logistics platform comprises:
determining a logistics platform server corresponding to the logistics platform;
sending an identifier request to the logistics platform server; and
receiving the logistics label identifier from the logistics platform server according to the identifier request.

4. The method according to claim 1, wherein the obtaining the logistics platform setting factor comprises at least one of: obtaining a preset logistics platform setting factor, and receiving a logistics platform setting factor from the terminal.

5. The method according to claim 1, wherein the logistics platform setting factor comprises one or more setting factors including:
a matching degree between coverage of a logistics platform and the logistics address information, a priority of a logistics platform, a quality of service index of a logistics platform, and a cost index of a logistics platform,

6. The method according to claim 5, wherein the quality of service index of a logistics platform comprises one or more quality indices including: a delivery time and a service feedback index of a logistics platform.

7. A method for obtaining logistics label information, applied to a terminal, comprising:
sending logistics address information to a logistics management server;
receiving logistics label information from the logistics management server; and
wherein the logistics label information is generated according to a logistics label identifier, the logistics label identifier corresponding to a logistics platform.

8. The method according to claim 7, wherein the logistics platform is determined according to a logistics platform setting factor and corresponds to the logistics address information.

9. The method according to claim 8, further comprising:
sending the logistics platform setting factor to the logistics management server.

10. The method according to claim 7, further comprising:
printing, after receiving the logistics label information from the logistics management server, a logistics label via a printing device;
wherein the logistics label is printed with the logistics label information.

11. The method according to claim 7, wherein the logistics label information is generated according to the logistics label identifier and an address segment identifier corresponding to the logistics address information.

12. The method according to claim 7, wherein the logistics platform setting factor comprises one or more setting factors including:
a matching degree between coverage of a logistics platform and the logistics address information, a priority of a logistics platform, a quality of service index of a logistics platform, and a cost index of a logistics platform.

13. The method according to claim 12, wherein the quality of service index of a logistics platform comprises one or more quality indices including: a delivery time and a service feedback index of a logistics platform.

14. A logistics management server, comprising:
one or more processors,
one or more non-transitory machine-readable memories coupled to the one or more processors and configured with instructions executable by the one or more processors to cause the server to perform operations comprising:
receiving logistics address information from a terminal;
obtaining a logistics platform setting factor;
determining, according to the logistics platform setting factor, a logistics platform corresponding to the logistics address information,
obtaining a logistics label identifier corresponding to the logistics platform;
generating logistics label information according to the logistics label identifier; and
sending the logistics label information to the terminal.

15. The logistics management server according to claim 14, wherein the operations further comprise generating an address segment identifier corresponding to the logistics address information.

16. The logistics management server according to claim 15, wherein the generating the logistics label information according to the logistics label identifier further comprises generating the logistics label information according to the logistics label identifier and the address segment identifier.

17. The logistics management server according to claim 14, wherein the obtaining the logistics label identifier corresponding to the logistics platform further comprises:
determining a logistics platform server corresponding to the logistics platform;
sending an identifier request to the logistics platform server via the transmitter; and
receiving the logistics label identifier from the logistics platform server according to the identifier request.

18. The logistics management server according to claim 14, wherein the obtaining the logistics platform setting factor comprises:
obtaining a preset logistics platform setting factor on the logistics management server; and
receiving the logistics platform setting factor from the terminal.

19. The logistics management server according to claim 14, wherein the logistics platform setting factor comprises one or more setting factors including:
a matching degree between coverage of a logistics platform and the logistics address information, a priority of a logistics platform, a quality of service index of a logistics platform, and a cost index of a logistics platform.

20. The logistics management server according to claim 19, wherein the quality of service index of a logistics platform comprises one or more quality indices including: a delivery time and a service feedback index of a logistics platform.
